(19) United States
(12) Patent Application Publication
(10) Pub. No.: US 2020/0273079 A1
(43) Pub. Date: Aug. 27, 2020

(54) AUTOMATIC ELECTRONIC MESSAGE DATA ANALYSIS METHOD AND APPARATUS

(71) Applicant: OATH INC., New York, NY (US)

(72) Inventors: Ariel RAVIV, Haifa (IL); Joel OREN, Haifa (IL); Irena GRABOVITCH-ZUYEV, Haifa (IL)

(21) Appl. No.: 16/284,342

(22) Filed: Feb. 25, 2019

(51) Int. Cl. G06Q 30/06; G06N 20/00

(52) U.S. Cl. CPC G06Q 30/0631; G06N 20/00

(57) ABSTRACT

Disclosed are systems and methods for improving interactions with and between computers in content generating, searching, hosting and/or providing systems supported by or configured with personal computing devices, servers and/or platforms. The systems interact to identify and retrieve data within or across platforms, which can be used to improve the quality of data used in processing interactions between or among processors in such systems. The disclosed systems and methods provide systems and methods for automatically analyzing electronic message data. The disclosed systems and methods automatically analyze data obtained from electronic messages using trained statistical models, such as time-series models for current data analysis and forecasting.

### FIELD OF THE DISCLOSURE

The present disclosure relates to electronic messaging and more particularly to analysis of data extracted from electronic messages.

### BACKGROUND

Currently, a large corpus of electronic messages are machine generated. One example of an electronic message is an electronic mail (or email) message. Recent studies have shown that more than 95% of non-spam electronic mail traffic transmitted via the Internet is machine generated. That is, most electronic mail, or email, message folders, e.g., inboxes, are largely comprised of machine-generated email messages (e.g., email messages generated automatically by computing devices using automated scripts). In many cases, the email messages originate from commercial entities and organizations. For example, automatically-generated email messages might contain a shipment notification, flight itinerary, purchase or order receipt, calendar event, newsletter, etc.

### SUMMARY

The present disclosure provides novel systems and methods for automatic analysis of electronic message data, such as and without limitation data extracted from electronic mail messages or other electronic messages. Since a majority of electronic messages are machine generated, such electronic message traffic is structured and repetitive in nature. The structure and repetitiveness of the electronic message traffic is leveraged to obtain data from the electronic messages, which data can then be used in generating features for use as training data to train a number of machine-learned models (e.g., time-series model(s)) for use in forecasting and other data analysis, such as and without limitation trend analysis. Disclosed systems and methods perform time series analysis using data extracted from electronic messages (and optionally other data associated with the extracted data) for analysis of current data and prediction of future data (e.g., forecasting).

Online shopping is growing rapidly. In a recent report from the Census Bureau of the Department of Commerce, in 2017, consumers spent $453.46 billion online (on the web) for retail purchases, which is a 16% increase over 2016 (in which consumers spent $390.99 billion). The Census Bureau reported that the growth rate in 2017 is the highest growth rate since 2011, when online sales grew 17.5% over 2010. In addition and according to a recent study, most online shopping can be tied to electronic messaging (e.g., electronic mail messaging), where 92% of Americans receive coupons and deals from stores where they shop, and where the vast majority of online receipts, delivery notifications, etc. are delivered. By way of a non-limiting example, electronic messages can include order confirmation data, receipt data, delivery data, etc. for items (such as and without limitation goods or services) purchased by users (e.g., electronic messaging system users).

Online item purchases reflect online user preferences (e.g., item preferences such as products, goods, services and the like). Preference information, including trends in user preferences (with respect to products, goods, services, and the like) about online users is valuable to a number of online platforms, engines, systems, including without limitation eCommerce, online targeted advertising, internet searching, item recommendation, social networking, and the like online platforms, engines and systems. To date, however, there is no computing method, device, system and/or platform that enables use of information (e.g., item purchase information) from electronic messages in determining trends, e.g., purchase trends, trends in user preferences, etc., which information can be used by systems involved in eCommerce, targeted advertising, item recommendation, electronic social networking, etc.

In addition, prior to the disclosed systems and methods, there was no mechanism for automatically transforming raw data, such as item purchase data, from electronic messages into data that can be automatically analyzed to discover trends, forecasts, etc. with respect to item purchases, which can be used in determining user preferences (e.g., with respect to items purchases and inferences based on item purchases) and trends in user preferences. In addition, the raw data can be used in determining relationships between customers, products and commercial domains can be automatically determined. The disclosed methods and systems leverage the raw data contained in electronic messages and provide useful information applicable to many applications, such as eCommerce, online targeted advertising, internet searching, item recommendation, social networking, and the like applications.

By efficiently aggregating and automatically analyzing information included in electronic messages, trends can be automatically detected. Some non-limiting examples of trends automatically detected using electronic message data include without limitation trends in user consumption (e.g., purchase) of certain items (e.g., products, goods, services, etc.), trends in affinity to certain brands or merchants, spending characteristics across different demographic segments, etc. Such information can be used by online web site providers to target online advertising, by merchants to identify what items to offer for sale on their web sites, etc.

According to some embodiments, the disclosed systems and methods first obtain data from electronic messages, such as and without limitation electronic messages comprising item purchase information including without limitation order confirmation, purchase receipt, delivery notification, etc. electronic messages. The obtained data can comprise purchase information, such as and without limitation information identifying an item (e.g., product, good, service, etc.) such as and without limitation an item name, model, manufacturer information, uniform product code (UPC), brand identification information, etc.), merchant information (e.g., merchant email address, merchant name, merchant location and the like), price, date of purchase, delivery information (e.g., delivery date, delivery address, etc.) and the like. The obtained data can also include information about the user, such as and limitation user identification information (e.g., user name, online user account identification, email address, etc.), geographic location (e.g., delivery address), and the like. In some embodiments, the disclosed systems and methods associate the product information with the user information and the merchant information. By way of a non-limiting example, product purchases across merchants can be automatically aggregated to yield various measures, including without limitation a number of purchases per item across merchants.

The disclosed systems and methods can automatically identify a common label (also referred to herein as an item name) for an item using the data obtained from electronic messages. In the data obtained from electronic messages, an item can be represented using descriptive information that includes the item name commonly used for the item as well as other information. For example, in addition to a name, an item's description can include features of the item, such as color, size, etc., which can vary by purchase. In a process referred to herein as item canonicalization, a canonical, or common, label (or name) for an item can be automatically determined, from the item's descriptive information, by excluding, the information that varies across occurrences of the item in electronic messages. For example, an Apple® iPhone X® has features such as color, storage space, carrier, condition as well as other information that can vary across data extracted from electronic messages. Item canonicalization provides a mechanism to automatically determine a canonical, or common, label for an item by culling variable information from the item's description in the electronic messages. In accordance with some embodiments, the resulting canonical label can be used to merge occurrences (e.g., purchases) of the same item (e.g., merge purchases of Apple® iPhone X®).

The disclosed systems and methods can automatically generate features using the data obtained from the electronic messages. In some embodiments, data from the electronic messages can be aggregated across merchant domains (e.g., sender domains of merchants sending electronic messages) to automatically generate a number of measures, or metrics, for each of a number of products for a given time period (e.g., hourly, daily, weekly, monthly, seasonally, etc.). For example, a number of occurrences of an item across merchant domains can be determined and used as a popularity score associated with the item. For example, an item's popularity score can correspond to the number of purchases of the item, in a given time period, determined from the data obtained from electronic messages sent/received in the time period (or electronic messages identifying a purchase date without the given time period). The popularity score for a given product can be for a given demographic segment (e.g., age, race, gender, ethnicity, education, family size, religion, etc.), or across demographic segments. Some further non-limiting examples of measures, or metrics, that can be generated using the obtained data include, for a given product and over a given time period, price ranges, a list of currencies used in the purchase, a list of item brands, delivery dates, delivery locations, etc.

In addition, the disclosed systems and methods can automatically generate implicit features to supplement the data obtained from the electronic messages and the product attributes. One example of an implicit feature is an item category. In accordance with at least one embodiment, disclosed systems and methods assign an item (e.g., a product, service, etc.) to a category (e.g., product category, service category, etc.) using information about the item, such as an item name (e.g., “Apple iPhone X”), and using an item category taxonomy. By way of a non-limiting example, an item category taxonomy (e.g., the Product Taxonomy, or GPT, from Google®) can provide a hierarchy of categories, which can be used in generating training data for training a model to infer item categories. For example, in the GPT, the hierarchical categorization for the Apple ® iPhone X® would be “Electronics>Communications>Telephone>Mobile Phones.”

In accordance with at least one embodiment, the item categorization training data can be maintained in a data store and can comprise a plurality of labeled samples (e.g., each sample corresponding to an item name and an annotation, or label, indicating the category, which can be a hierarchical category designation (e.g., a GPT hierarchical categorization). Each item name and category label in the data store can be used as a training example with machine learning to train an item categorization model to predict an item's category. Given an item's name as input (without a label, or annotation) to the trained item categorization model, the model can be used to infer the item's category.

Other non-limiting examples of implicit product features, in accordance with one or more embodiments, include user age and gender determination, repetitive purchase determinations, and premium product determination. User age or gender can be determined using information associated with a user account (e.g., an electronic messaging system user account, a merchant site user account, etc.). Another mechanism that can be used alone or in combination with user account information is an age and/or gender classifier that is trained to infer an age and/or gender of a user. With repetitive purchase determination, an item (such as and without limitation a cleaning product, pet food, diapers) that is purchased on a regular basis (also referred to as repeated purchase) can be detected using a data analysis technique, such as time series analysis. Such analysis can detect periodic trends (daily, weekly, monthly, season, etc.). Premium item determination can detect items that are priced above other items in an item category by performing price analysis of items belonging to the category.

The disclosed systems and methods can store the obtained electronic messaging data, the canonicalized item name, and implicit item features in a data store, such as a database, and can then automatically generate a number of database indexes, such as and without limitation indexes on item name, brand, merchant, price, popularity, and date, etc., for efficiently pivoting over the indexed fields in a specified period of time. The item indexing provides a mechanism to perform quick analysis of cross sections of items.

The disclosed systems and methods then automatically perform model learning to generate a number of models using data retrieved from one or more databases (e.g., retrieved using one or indexes). By way of a non-limiting example, the model can be a time-series analysis model that is automatically trained using machine learning. In accordance with one or more embodiments, a selected time series analysis technique is used to generate a model that can then be used to analyze current data (e.g., analyze trends in current data) and predict (forecast) future data (e.g., future trends).

The disclosed systems and methods then use one or more time-series models to automatically perform one or more tasks, such as and without limitation automatically predicting an upcoming, or future, trend involving consumption of one or more items, automatically performing demand forecasting of popular products (such as and without limitation in anticipation of seasonal increases in online shopping), automatically detecting decreases in product families, categories, etc. (e.g., winter sports equipment), and the like.

In accordance with one or more embodiments, a number of time-series models generated in accordance with one or more embodiments, can be used to generate an item ranking (e.g., of top items) ordered by a given measure (e.g., number of purchases made by electronic message system users (also referred to herein as a popularity score), average price, etc.). In this example, the time-series analysis model(s) can automatically predict a ranked ordering (e.g., a ranked listing) for a number of time periods (e.g., daily, weekly, monthly, seasonally, etc.).

In accordance with one or more embodiments, the time-series analysis model(s) can be generated using electronic messages from a certain time period and the time-series analysis model(s) can be updated periodically using new electronic messages (e.g., electronic messages from a more recent time period, or periods). In so doing, the model(s) can evolve over time by retraining the model(s) using the new electronic messages.

It will be recognized from the disclosure herein that embodiments of the instant disclosure provide improvements to a number of technology areas, for example those related to systems and processes that involve eCommerce, online targeted advertising, internet searching, item recommendation, social networking, and the like online platforms, engines and systems. The disclosed systems and methods can effectuate increased speed and efficiency in the ways that users (e.g., online merchants, website providers, consumers, brands, advertisers) can access purchase trend information using a new source of data in the form of electronic messages, thereby increasing user effectiveness, efficiency and productivity, as the disclosed systems and methods, inter alia, use electronic message data to train a number of models that can then be applied to predict upcoming trends in item purchases (which can be used in determining item preferences of users), which can then be used in eCommerce, online targeted advertising, internet searching, item recommendation, social networking, and the like online platforms, engines and systems.

In accordance with one or more embodiments, a method is disclosed which includes obtaining, by a computing device and from a plurality of electronic messages of a plurality of electronic messaging system users, item purchase data indicative of past purchases of a number of items by the users during a time span, the item purchase data, for an item of the number, comprising temporal data indicative of a timing of each past purchase of the item; determining, by the computing and for each item of the number, a set of popularity scores corresponding to a set of time periods of the time span, the determining comprising, for an item of the number and a time period of the set, determining a popularity score corresponding to a number of purchases of the item in the time period; generating, by the computing device, training data using the set of popularity scores corresponding to the set of time periods associated with each item of the number of items; training, by the computing device and using the training data and a machine learning process, a model for generating popularity score predictions; generating, by the computing device and using the trained model, output comprising, for each item of the number of items, a set of predicted popularity scores corresponding to a set of future time periods; and providing, by the computing device, output of the trained model.

In accordance with one or more embodiments, a non-transitory computer-readable storage medium is provided, the non-transitory computer-readable storage medium tangibly storing thereon, or having tangibly encoded thereon, computer readable instructions that when executed cause at least one processor to perform a method for automatically analyzing electronic message data.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a schematic block diagram illustrating components of an exemplary system in accordance with embodiments of the present disclosure;

FIG. 4 is a flowchart illustrating steps performed in accordance with some embodiments of the present disclosure;

FIGS. 5 and 6 are diagrams of an exemplary example of a non-limiting embodiment in accordance with some embodiments of the present disclosure; and

FIG. 7 is a block diagram illustrating the architecture of an exemplary hardware device in accordance with one or more embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Wi-Fi, Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations. For example, a simple smart phone, phablet or tablet may include a numeric keypad or a display of limited functionality, such as a monochrome liquid crystal display (LCD) for displaying text. In contrast, however, as another example, a web-enabled client device may include a high resolution screen, one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like.

A client device may include or may execute a variety of possible applications, such as a client software application enabling communication with other devices, such as communicating one or more messages, such as via email, for example Yahoo!® Mail, short message service (SMS), or multimedia message service (MMS), for example Yahoo! Messenger®, including via a network, such as a social network, including, for example, Tumblr®, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing or displaying various forms of content, including locally stored or streamed video, or games (such as fantasy sports leagues). The foregoing is provided to illustrate that claimed subject matter is intended to include a wide range of possible features or capabilities.

The detailed description provided herein is not intended as an extensive or detailed discussion of known concepts, and as such, details that are known generally to those of ordinary skill in the relevant art may have been omitted or may be handled in summary fashion.

The instant disclosure provides a novel solution addressing the immediate demand for an automated system, application and/or platform that can analyze electronic messaging data. The present disclosure provides novel systems and methods for automatic analysis of electronic message data, including using electronic messaging data to determine an item name and to automatically generate features for each item, such as and without limitation an item popularity score.

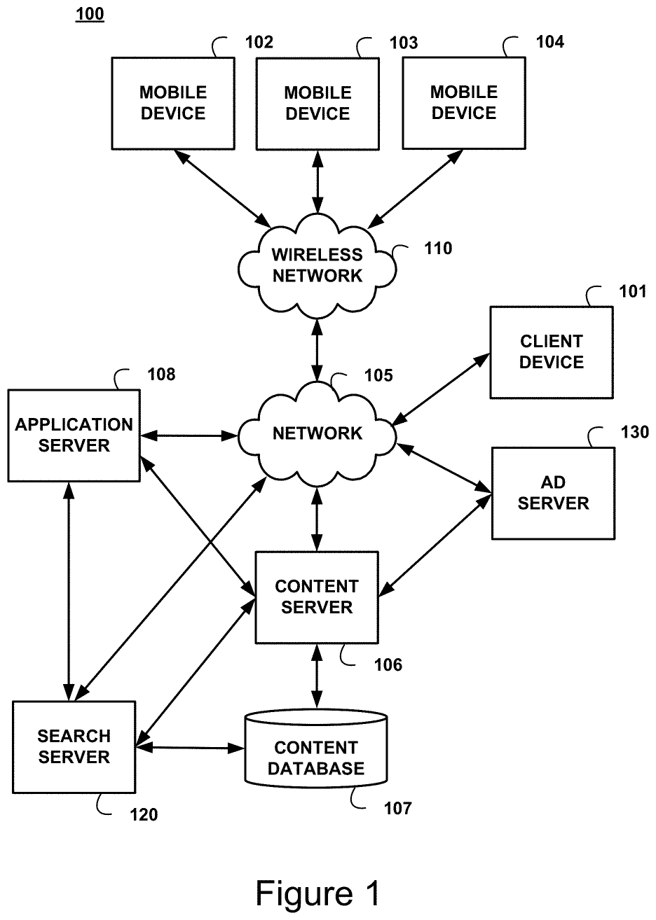

Certain embodiments will now be described in greater detail with reference to the figures. The following describes components of a general architecture used within the disclosed system and methods, the operation of which with respect to the disclosed system and methods being described herein. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)−network 105, wireless network 110, mobile devices (client devices) 102-104 and client device 101. FIG. 1 additionally includes a variety of servers, such as content server 106, application (or “App”) server 108, search server 120 and advertising (“ad”) server 130.

One embodiment of mobile devices 102-104 is described in more detail below. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, smart watch, tablet computers, phablets, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and an HD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier.

In some embodiments, mobile devices 102-104 may also communicate with non-mobile client devices, such as client device 101, or the like. In one embodiment, such communications may include sending and/or receiving messages, searching for, viewing and/or sharing photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Client devices 101-104 computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Network 105 is configured to couple content server 106, application server 108, or the like, with other computing devices, including, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, QUIC (Quick UDP Internet Connection), DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within or accessible to an electronic social networking site. A social network refers generally to an electronic network of individuals, such as acquaintances, friends, family, colleagues, or co-workers, which are coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, phablets, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server 106 may include a device that includes a configuration to provide content via a network to another device. A content server 106 may, for example, host a site or service, such as streaming media site/service (e.g., YouTube®), an email platform or social networking site, or a personal user site (such as a blog, vlog, online dating site, and the like). A content server 106 may also host a variety of other sites, including, but not limited to business sites, educational sites, dictionary sites, encyclopedia sites, wikis, financial sites, government sites, and the like. Devices that may operate as content server 106 include personal computers desktop computers, multiprocessor systems, microprocessor-based or programmable consumer electronics, network PCs, servers, and the like.

Content server 106 can further provide a variety of services that include, but are not limited to, streaming and/or downloading media services, search services, email services, photo services, web services, social networking services, news services, third-party services, audio services, video services, instant messaging (IM) services, SMS services, MMS services, FTP services, voice over IP (VOIP) services, or the like. Such services, for example a video application and/or video platform, can be provided via the application server 108, whereby a user is able to utilize such service upon the user being authenticated, verified or identified by the service. Examples of content may include images, text, audio, video, or the like, which may be processed in the form of physical signals, such as electrical signals, for example, or may be stored in memory, as physical states, for example.

An ad server 130 comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics. Such systems can incorporate near instantaneous auctions of ad placement opportunities during web page creation, (in some cases in less than 500 milliseconds) with higher quality ad placement opportunities resulting in higher revenues per ad. That is advertisers will pay higher advertising rates when they believe their ads are being placed in or along with highly relevant content that is being presented to users. Reductions in the time needed to quantify a high quality ad placement offers ad platforms competitive advantages. Thus higher speeds and more relevant context detection improve these technological fields.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108, 120 and 130 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In some embodiments, users are able to access services provided by servers 106, 108, 120 and/or 130. This may include in a non-limiting example, authentication servers, search servers, email servers, social networking services servers, SMS servers, IM servers, MMS servers, exchange servers, photo-sharing services servers, and travel services servers, via the network 105 using their various devices 101-104. In some embodiments, applications, such as a streaming video application (e.g., YouTube®, Netflix®, Hulu®, iTunes®, Amazon Prime®, HBO Go®, and the like), blog, photo storage/sharing application or social networking application (e.g., Flickr®, Tumblr®, and the like), can be hosted by the application server 108 (or content server 106, search server 120 and the like). Thus, the application server 108 can store various types of applications and application related information including application data and user profile information (e.g., identifying and behavioral information associated with a user). It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106, 108, 120 and/or 130.

Moreover, although FIG. 1 illustrates servers 106, 108, 120 and 130 as single computing devices, respectively, the disclosure is not so limited. For example, one or more functions of servers 106, 108, 120 and/or 130 may be distributed across one or more distinct computing devices. Moreover, in one embodiment, servers 106, 108, 120 and/or 130 may be integrated into a single computing device, without departing from the scope of the present disclosure.

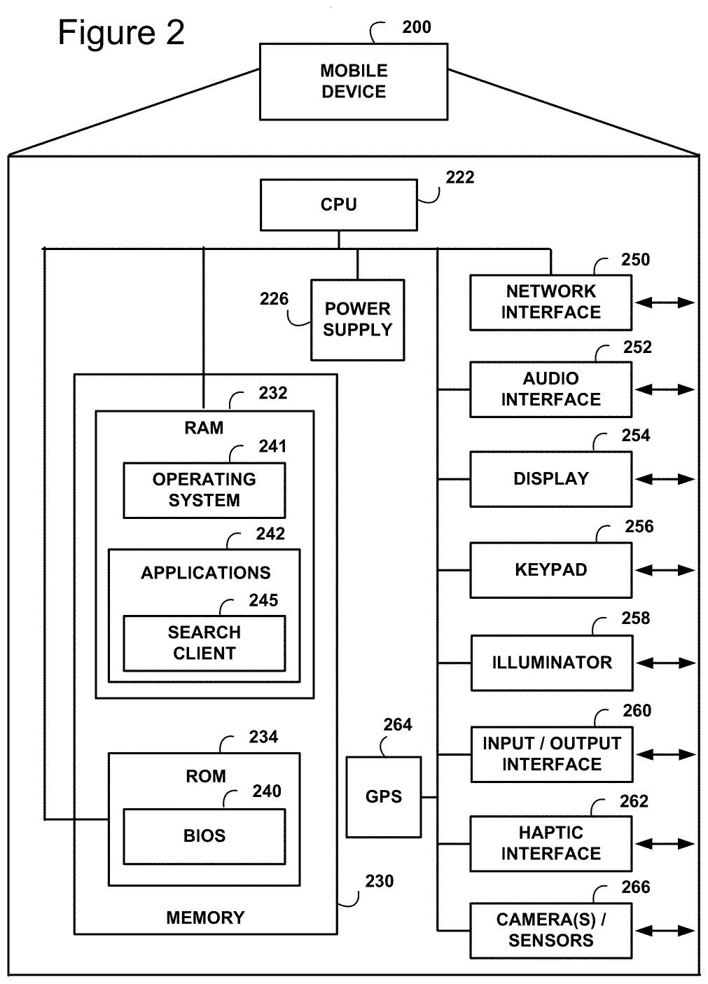

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. Device 200 can include one camera/sensor 266, or a plurality of cameras/sensors 266, as understood by those of skill in the art. The positioning of the camera(s)/sensor(s) 266 on device 200 can change per device 200 model, per device 200 capabilities, and the like, or some combination thereof.

Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies as discussed above. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the client device 200 receives a communication from another user.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, client device 200 may through other components, provide other information that may be employed to determine a physical location of the device, including for example, a MAC address, Internet Protocol (IP) address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by client device 200 to store, among other things, applications 242 and/or other data. For example, data stores may be employed to store information that describes various capabilities of client device 200. The information may then be provided to another device based on any of a variety of events, including being sent as part of a header during a communication, sent upon request, or the like. At least a portion of the capability information may also be stored on a disk drive or other storage medium (not shown) within client device 200.

Applications 242 may include computer executable instructions which, when executed by client device 200, transmit, receive, and/or otherwise process audio, video, images, and enable telecommunication with a server and/or another user of another client device. Other examples of application programs or “apps” in some embodiments include browsers, calendars, contact managers, task managers, transcoders, photo management, database programs, word processing programs, security applications, spreadsheet programs, games, search programs, and so forth. Applications 242 may further include search client 245 that is configured to send, to receive, and/or to otherwise process a search query and/or search result using any known or to be known communication protocols. Although a single search client 245 is illustrated it should be clear that multiple search clients may be employed. For example, one search client may be configured to enter a search query message, where another search client manages search results, and yet another search client is configured to manage serving advertisements, IMs, emails, and other types of known messages, or the like.

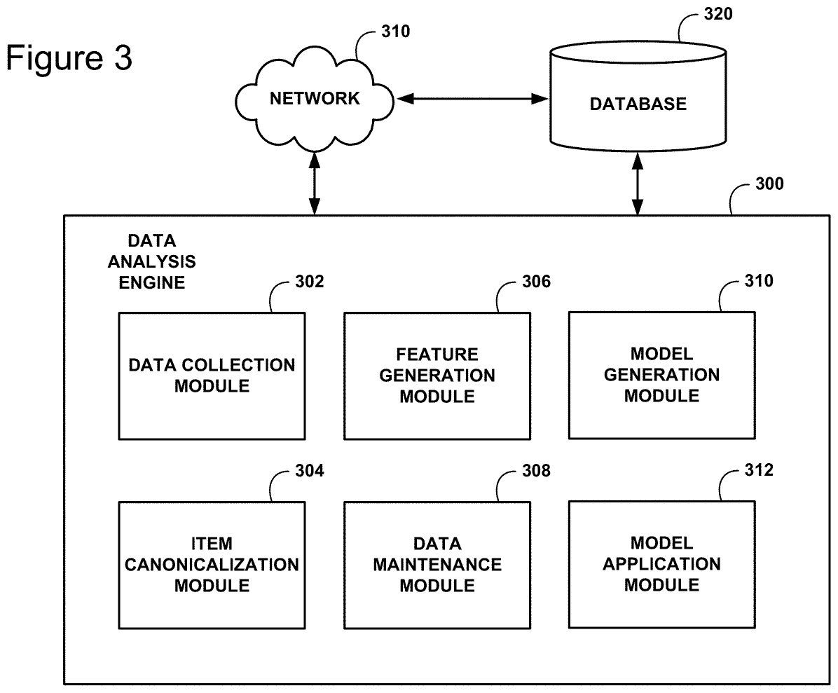

FIG. 3 is a block diagram illustrating the components for performing the systems and methods discussed herein. FIG. 3 includes a data analysis engine 300, network 310 and database 320. The engine 300 can be a special purpose machine or processor and could be hosted by an application server, content server, social networking server, web server, search server, content provider, email service provider, ad server, user's computing device, and the like, or any combination thereof.

According to some embodiments, engine 300 can be embodied as a stand-alone application that executes on a user device. In some embodiments, the engine 300 can function as an application installed on the user's device, and in some embodiments, such application can be a web-based application accessed by the user device over a network.

The database 320 can be any type of database or memory, and can be associated with a server on a network (such as and without limitation a data analysis server, content server, search server, application server, etc.,) or a user's device. Database 320 comprises a dataset of data and metadata associated with local and/or network information related to users, services, applications, content (e.g., video) and the like. Such information can be stored and indexed in the database 320 independently and/or as a linked or associated dataset. It should be understood that the data (and metadata) in the database 320 can be any type of information and type, whether known or to be known, without departing from the scope of the present disclosure.

According to some embodiments, database 320 can store data for users, e.g., user data. According to some embodiments, the stored user data can include, but is not limited to, information associated with a user's profile, user interests, user behavioral information, user attributes, user preferences or settings, user demographic information, user location information, user biographic information, and the like, or some combination thereof. In some embodiments, the user data can also include, for purposes training one or more time-series models, user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 320 can be any type of information related to a user, content, a device, an application, a service provider, a content provider, whether known or to be known, without departing from the scope of the present disclosure.

According to some embodiments, database 320 can store data and metadata associated with electronic messages of users of one or more electronic messaging systems. For example, the electronic messages can be electronic mail messages in one or more electronic mail messaging systems, text messages in one or more text messaging systems, etc.

According to some embodiments, database 320 can store data extracted from electronic messages as well as data generated using data extracted from electronic messages, such as and without limitation aggregate attributes, implicit product features, premium product identification information and the like. In addition and according to some embodiments, database 320 can store machine-learning training data as well as models trained using machine learning and the training data. In accordance with some embodiments, database 320 can store model output, such as and without limitation trend predictions, demand forecasts, and the like.

According to some embodiments, database 320 can maintain a number of indexes on data stored in database 320 to enable efficient pivoting over indexed fields and over specified time periods, and to enable efficient analysis of product cross sections. Some non-limiting examples of indexes include indexes on product title, brand, merchant, price, popularity, date, and the like.

The network 310 can be any type of network such as, but not limited to, a wireless network, a local area network (LAN), wide area network (WAN), the Internet, or a combination thereof. The network 310 facilitates connectivity of the engine 300, and the database of stored resources 320. Indeed, as illustrated in FIG. 3, the engine 300 and database 320 can be directly connected by any known or to be known method of connecting and/or enabling communication between such devices and resources.

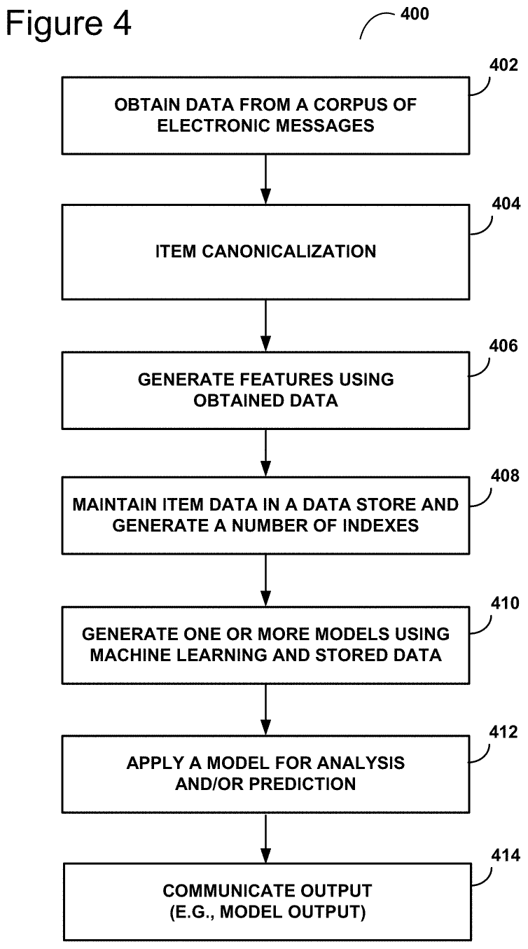

The principal processor, server, or combination of devices that comprises hardware programmed in accordance with the special purpose functions herein is referred to for convenience as engine 300, and includes data collection module 302, item canonicalization module 304, feature generation module 306, data maintenance module 308, model generation module 310 and model application module 312. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed with reference to FIG. 4.

As discussed in more detail below, the information processed by the engine 300 can be supplied to the database 320 in order to ensure that the information housed in the database 320 is up-to-date as the disclosed systems and methods leverage real-time information and/or behavior associated with electronic messages processed by engine 300. In accordance with some embodiments, engine 300 can periodically update the machine-trained models using new electronic messages, so that a given time-series model and the output generated by the given model can evolve over time based on new (or more recent) electronic messages.

While the discussion below may involve examples of electronic mail messages, it should be apparent that any type of electronic message can be used with embodiments of the present disclosure. In addition and while the below discussion may involve examples of products, it should be apparent that other types of items, such as services, goods, etc., can be used with embodiments of the present disclosure.

FIG. 4 provides a process flow overview in accordance with one or more embodiments of the present disclosure. Process 400 of FIG. 4 details steps performed in accordance with exemplary embodiments of the present disclosure for automatically analyzing electronic messages data. According to some embodiments, as discussed herein with relation to FIG. 4, the process involves obtaining data from a corpus of electronic messages (e.g., electronic messages associated with a certain time period, such as and without limitation electronic messages sent and/or received in a given day, week, month, year, seasonal period, etc.). At least some of the data extracted from the corpus of electronic messages can be used to generate additional data, such as and without limitation aggregation attributes (e.g., product aggregation attributes) and/or implicit features of the data (e.g., implicit product features). In accordance with some embodiments, at least some of the data extracted from the corpus of electronic messages as well as the generated data is stored in a datastore (e.g., a database) and various indexes can be generated on the stored data. One or more models are trained using at least some of the stored data and machine learning. Each model of the number can be applied in predicting a future trend.

At step 402, which is performed by data collection module 302, data is obtained from a corpus of electronic messages. In accordance with some embodiments, the corpus of electronic messages comprise electronic messages associated with item purchases. Some examples of electronic messages comprising item purchase information including without limitation order confirmation, purchase receipt, delivery notification, etc. electronic messages.

The obtained data can comprise purchase information, such as and without limitation information identifying an item (e.g., product, good, service, etc.) such as and without limitation an item name, model number, serial number, brand information, uniform product code (UPC), or other identifying information, brand identification information, etc.), merchant information (e.g., merchant name, electronic messaging address, such as an email address comprising a sender domain, physical address for merchant, and the like), purchase price, date of purchase, delivery information (e.g., delivery date, delivery address, etc.) and the like. The obtained data can also include information about the user, such as and limitation user identification information (e.g., user name, email address), geographic location (e.g., delivery address), and the like. In at least one embodiment, the disclosed systems and methods associate the item information with the user information and the merchant information. By way of a non-limiting example, item purchases across merchants can be automatically aggregated to yield a number of purchases per item. In some embodiments, the number of purchases can be used as a popularity score for an item (e.g., a product, service, etc.).

Embodiments of the present disclosure can use any one or more mechanisms for extracting data from the electronic messages in the corpus. By way of some non-limiting examples, one mechanism for extracting electronic messages comprises extraction rules that can be used to extract data from the electronic messages. As is disclosed in Grabovitch-Zuyev et al., Automatic Electronic Message Content Extraction Method And Apparatus, U.S. patent application Ser. No. 16/272,285, filed on Feb. 11, 2019, extraction rules can be automatically generated and used to automatically extract data from an electronic message and associate an annotation providing context, or meaning, to the extracted data. In any case, the extracted data (alone or in combination with annotations) is stored in a data store for retrieval at step 402.

At step 404, which is performed by item canonicalization module 304, items can be represented using a canonical (e.g., standard, normal or common) form. In the electronic messages from which data is obtained (at step 402), the same item can be represented in many different ways. An item can be represented using descriptive information that includes a name (e.g., a product name) commonly used for the item as well as other information. For example, in addition to a name, an item's description can include features of the item, such as color, size, etc., which can vary. Item canonicalization provides a mechanism for standardizing the item's representation across the data obtained from the electronic messages. By determining a canonical form for occurrences of an item, it is possible to aggregate information across the occurrences. A canonical, or common, label (or name) for an item can be automatically determined, from the item's descriptive information, by excluding, the information that varies across occurrences of the item in electronic messages.

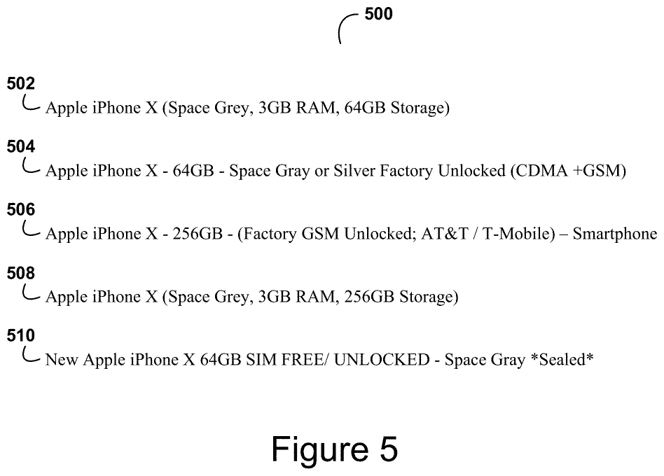

Reference is made to FIG. 5 which provides an example, in accordance with some embodiments, of data obtained from electronic messages about purchases of an Apple® iPhone X®. In the example, data 500 includes rows 502, 504, 506, 508 and 510. Each row comprises data (extracted from an electronic message) about a different purchase of an Apple® iPhone X®. Each row includes the product's name as well as additional descriptive information (e.g., color storage space, and carrier, etc.) which varies across the different instances. While the additional information is useful at some level, it masks the fact that the same item is referenced in each row. Item canonicalization identifies a canonical label (or common item name) for use with all of the instances. In some embodiments, the canonical label provides a mechanism for grouping or aggregating information. Using canonicalization, a common item name (e.g., Apple® iPhone X®) can be identified and then used to merge occurrences (e.g., purchases) of the same item (e.g., merge purchases of Apple® iPhone X®).

In accordance with some embodiments, canonicalization can be performed using rules, which may be generated automatically or manually. For example, a rule can be used to parse the descriptive information in each row (or instance) in data 500 to locate and extract “Apple iPhone X” from each instance. By way of another non-limiting example, a named-entity recognition (NER) technique can be used to locate and classify a named entity occurrences in unstructured text into defined categories. For example, an NER technique can be used to locate an item name (e.g., “Apple iPhone X”) in each descriptive information instance in data 500.

As yet another non-limiting example, item canonicalization can be done by grouping, or clustering, the instances using each instance's descriptive information and, for each cluster, identifying some portion of the descriptive information shared by a number of instances as the canonical label (e.g., item name, product name, etc.) used for each instance assigned to the cluster. In some embodiments, the descriptive information can be pre-processed to eliminate any known extraneous portions before clustering.

By way of a non-limiting example, Min-Wise Independent Permutations Hash-Locality-Sensitive Hashing (or MinHash-LSH) can be used to identify similar instances of descriptive information (with or without known extraneous information), for purposes of assigning each instance to a cluster. Then, for each cluster, a canonical label (e.g., product name) can be determined to be a string constructed from tokens common to a large fraction of the cluster member.

Referring again to FIG. 4, at step 406 (which is executed by feature generation module 306), features can be automatically generated using the data obtained by the data collection module 302 at step 402. In some embodiments, data from the electronic messages can be aggregated across merchant domains (e.g., sender domains of merchants sending electronic messages) to automatically generate a number of measures, or metrics, for each of a number of items for a given time period (e.g., hourly, daily, weekly, monthly, seasonally, etc.). For example, a number of occurrences (e.g., number of purchases) of an item (determined across merchants) can be used as a popularity score associated with the item. For example, an item's popularity score can correspond to the number of purchases of the item, in a given time period, determined from the data obtained from electronic messages sent/received in the time period. The popularity score for a given item can be determined for a given demographic segment (e.g., age, race, gender, ethnicity, education, family size, religion, etc.), across demographic segments, etc. In accordance some embodiments, a popularity score can be automatically generated over a number of time periods for each item of a plurality of items. Some further non-limiting examples of measures, or metrics that can be generated using the obtained data include (for a given item and over a given time period) price ranges, list of currencies used in purchasing the item, a list of product brands, delivery dates, delivery locations, etc.

In some embodiments, a product category can be determined at step 406 (by the feature generation module 306) using the data obtained from the electronic messages. In accordance with at least one embodiment, disclosed systems and methods assign an item (e.g., a product, service, etc.) to a category (e.g., product category, service category, etc.) using information about the item, such as an item name (e.g., “Apple iPhone X”), and using an item category taxonomy. By way of a non-limiting example, an item category taxonomy (e.g., the Product Taxonomy, or GPT, from Google®) can provide a hierarchy of categories, which can be used in generating training data for training a model to infer item categories. For example, in the GPT, the hierarchical categorization for the Apple ® iPhone X® would be “Electronics>Communications>Telephone>Mobile Phones.” A trained model can be used with any type of item, including a product, service, a good, etc. and any type of category, including product, services (e.g., digital subscription services, food and grocery deliveries, etc.) etc.

In accordance with at least one embodiment, the item categorization training data can be maintained in a data store and can comprise a plurality of labeled samples (e.g., each sample corresponding to an item name and an annotation, or label, indicating the category, which can be a hierarchical category designation (e.g., a GPT hierarchical categorization). Each item name and category label in the data store can be used as a training example with machine learning to train an item categorization model to predict an item's category. Given an item's name as input (without a label, or annotation) to the trained item categorization model, the model can be used to infer the item's category.

Other non-limiting examples of implicit product features, in accordance with one or more embodiments, include user age and gender determination, repetitive purchase determinations, and premium product determination. User age or gender can be determined using information associated with a user account (e.g., an electronic messaging system user account, a merchant site user account, etc.). Another mechanism that can be used alone or in combination with user account information is an age and/or gender classifier that is trained to infer an age and/or gender of a user. With repetitive purchase determination, an item (such as and without limitation a cleaning product, pet food, diapers) that is purchased on a regular basis (also referred to as repeated purchase) can be detected using a data analysis technique, such as time series analysis. Such analysis can detect periodic trends (daily, weekly, monthly, season, etc.). Premium item determination can detect items that are priced above other items in an item category by performing price analysis of items belonging to the category.

At step 408, which is performed by data maintenance module 308, purchase-level data corresponding to each purchase (or other type of consumption) determined using the data obtained from the electronic messages at step 402 can be maintained in a data store (e.g., one or more tables in a relational databased or other database). The purchase-level data corresponding to a given purchase instance can comprise such information as an item name (determined at step 404), item category (determined at step 406), price, purchase date, merchant identification information, delivery date, delivery location, user identification information, etc. The merchant identification can be used to access other merchant information (e.g., stored in a merchant database table), such as and without limitation merchant domain name, merchant geographic location, etc. The user identification information can be used to access other user information (e.g., stored in a user database table), such as user online account identifier, email address, address, age, gender, etc. In some embodiments, the data store can comprise brand information (e.g., Apple, Samsung, LG, etc.)

In some embodiments, the data store can store aggregate-level information, such as measures (or scores) determined at step 406. For example, for a given item, the data store can store a set of popularity measures for the item, each measure in the set corresponding to the item, a time period and/or a demographic segment. The data store can store a price range for a given item using the purchase price information obtained from the electronic messaging data. The purchase price information can be a single price range or a set of price ranges, each price range in the set corresponding to a time period, a geographic region, etc.

In some embodiments, data maintenance can comprise automatically generating a number of database indexes, such as and without limitation indexes on item name, brand, merchant, price, popularity, and date, etc., for efficiently pivoting over the indexed fields in a specified period of time. The item indexing provides a mechanism to perform quick data retrieval for analysis.

At step 410, a number of models are generated using machine learning and training data (e.g., data retrieved from one or more databases using one or indexes) generated using data retrieved from one or more databases (e.g., retrieved using one or indexes). By way of a non-limiting example, the model can be a time-series analysis model that is automatically trained using machine learning. In accordance with one or more embodiments, a selected time series analysis technique is used to generate a model that can then be used to analyze current data (e.g., analyze trends in current data) and predict (forecast) future data (e.g., future trends).

By way of a non-limiting example of a time-series analysis model for analyzing observed data (e.g., time series data, current or past) and/or for predicting (or forecasting) future data points using observed data is an autoregressive integrated moving average (ARIMA) model. The observed data is time series data (current, or past) comprising a sequence of data points taken at successive equally-spaced (e.g., a given interval) points of time. The observed data can comprise data values (or data points) and associated time data at a given time interval (e.g., hourly, daily, monthly, annually, seasonally, etc.)

In modeling the time series data, an ARIMA model accounts for growth/decline pattern(s) in the data, the rate of change of the growth/decline pattern(s) and noise between consecutive time points. An ARIMA model analyzes the observed data using three operational parameters: p, d, q. The first parameter, p, (which relates to the auto-aggressive aspect of the model) represents the number of preceding Y (e.g., Y-axis) values added or subtracted to improve predictions based on local points of growth/decline in the data. The second parameter, d, (which relates to the integrated aspect of the model) represents the number of times the data has to be differenced to produce a stationary signal (a constant mean over time). A value of zero indicates that the data does not tend to go up or down over time. The third parameter, q, (which relates to the moving average aspect of the model) represents the number of preceding values for the error term that are added or subtracted to/from Y.

The values for each parameter can be determined empirically. For example, the model can be set to predict observed data (i.e., known data) and the parameters can be tested and determined based on a determined error (root mean square error) between the model prediction and the observed data. Another measure that can be used in validating a time-series model is Akaike Information Criteria (AIC), which is a measure of the relative quality of the model for a given set of data. The AIC value (e.g., the lowest value) can be used in selecting the values of the operational parameters. In addition, it is possible to use a time-series decomposition that decomposes the time series to view, in separate plots, the observed data, a trend component (of the observed data), a seasonality component and a noise component.

An ARIMA model is one example of a time-series analysis mechanism. Some other examples that can be used with one or more embodiments of the present disclosure include without limitation simple averaging, moving average, simple exponential smoothing, Holt's Linear Trend method and Holt-Winters Method.

At step 412 (of FIG. 4), at least one trained time-series model is applied to provide output, such as analysis of current data and/or to provide a prediction (or forecast) of future data. At step 414, the model output can be communicated to a client device.

By way of one non-limiting example, the time series data can comprise a set of popularity scores (e.g., representing a number of purchases of an item) for a given item and time data corresponding to each popularity score indicating a time period for the corresponding popularity score. A model, such as an ARIMA model, can be used (at step 412 of FIG. 4) to analyze the current popularity data (e.g., trends, seasonality, noisiness) and/or to predict the future popularity of the item. By way of a further non-limiting example, the model can be used with a number of items to predict future popularity of each item of the number. An item ranking ordered by popularity can be generated (at step 414) using the current popularity data and/or future (forecasted) popularity score.

In some embodiments, the ranking comprises, for each of a number of time periods, a ranked list of the items ordered by popularity score. The ranking can be output graphically, e.g., as a bar chart comprising, for each time period of a number of time periods, a bar corresponding to each item indicating the popularity score for the item. As yet another example, the ranking can be output as a line graph comprising, for each time period of a number of time periods, a line corresponding to each item with points along an item's corresponding line representing a popularity score for a given time interval. It should be apparent that other output displays can be used as well.

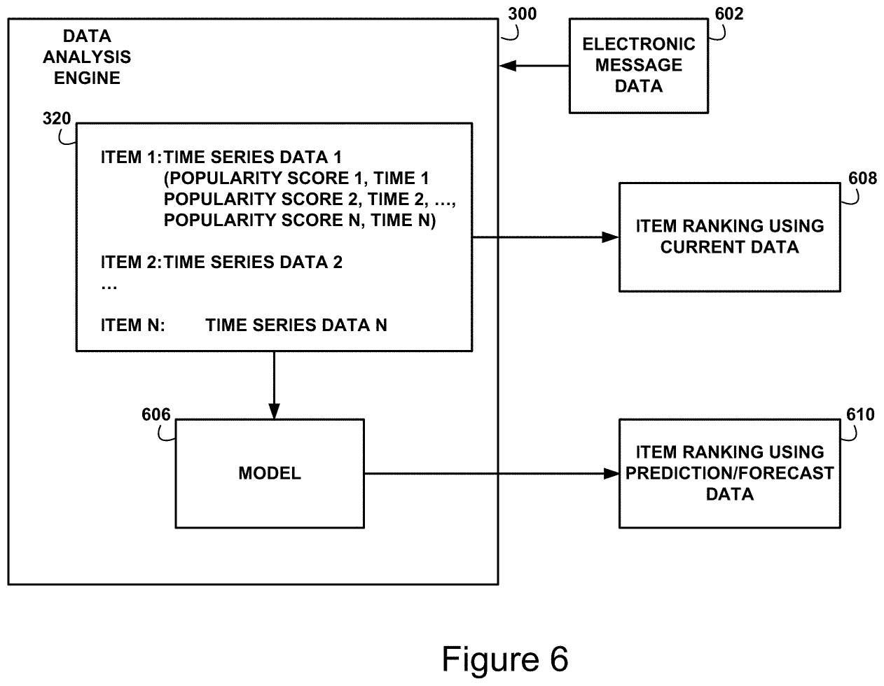

FIG. 6 provides an exemplary example in accordance with one or more embodiments. In the example electronic message data 604 is received by engine 300 (e.g., at step 402 of FIG. 4) from a number of electronic messages. By way of some non-limiting examples, the electronic messages (from which the electronic message data 602 is obtained) can be stored at an electronic messaging system server (or servers), electronic messaging system user electronic messaging folders (e.g., inbox, sent, etc. folders) or some combination of electronic message stores.

The electronic message data 602 is received by engine 300 (e.g., via step 402 of FIG. 4) periodically and used by the engine to (periodically) update its database 320 and its time-series model 606, enabling the data stored in database 320 and the model to evolve over time. In this example, the electronic message data 602 can be data from any type of electronic message, including without limitation electronic mail (or email) messages of electronic messaging (e.g., email) system users.

At least some of the electronic message 602 data can comprise data regarding purchases made by the electronic messaging system users. For example, the electronic messages 602 can comprise order confirmation data, delivery data, etc., which data can comprise item description information, purchase price, purchase date, order number, customer number, item description, delivery date, delivery location, user information, brand information, etc. Each electronic data instance corresponds to one electronic message and comprises data from the electronic message, which data can comprise at least one date of the message (e.g., sent date, received date, etc.). In some embodiments, the electronic data instance comprises a number of name-value pairs, each name-value pair comprising an annotation (e.g., purchase price) and a data value (e.g., $25.89).

As discussed herein, engine 300 can perform step 404 with each data instance to determine an item name. In addition, step 406 can be performed to determine features associated with each item, such as and without limitation a popularity score for each item (referenced by item name) for each time period covered by electronic message data 602 received by engine 300.

As illustrated in the example of FIG. 6, engine 300 can generate time series data for a number of items for a given time span comprising a number of time periods of a same interval. For example, the time span can be one year, and each time period can be a month of the year. For each item of the number, the time series data can comprise popularity score data (comprising a number of popularity scores indicative of a number of purchases of the item by electronic messaging users) and corresponding time data (comprising a number of times, each of which corresponding to a popularity score in the popularity score data and indicating a time period). For example, the interval for the time series might be monthly in which case the time data might comprise a month and year designation and the corresponding popularity score can represent a number of purchases of an item in a given month and year. As yet another example, the time interval might be per year and the time data might comprise a year designation and the corresponding popularity score can represent a number of purchases of an item in a given year. As discussed, at step 408 of FIG. 4, engine 300 can build one or more indexes of the data stored in database 320 so that the data can be retrieved efficiently.

In the example of FIG. 6, the time series data can be used to generate output 608, by the engine 300, comprising a ranking of the items (e.g., item₁ . . . itemₙ) ordered by current popularity score. In addition, in the example of FIG. 6, the time series data can be used by engine 300 (e.g., at step 410 of FIG. 4) as training data to train model 606 using machine learning (e.g., using ARIMA).

Model 606 can be used by engine 300 (at step 412 of FIG. 4) to generate popularity score predictions (e.g., future or forecasted popularity scores) for a number of future time periods for each item of the number of items (e.g., item₁ . . . itemₙ). In accordance with at least one embodiment, item rankings 608 and 610 include the top-ranked items selected from a plurality of items based on popularity score (e.g., current popularity score in the case of item ranking 608, or forecasted popularity score in the case of item ranking 610). In some embodiments, item rankings 608 and 610 can comprise more than one time interval. In the case of a multiple-interval ranking comprising the top-ranked items per interval, the items included in each interval can vary from one time interval to another. For example, one item may be one of the top-ranked items in one time interval but be excluded from the top-ranked items in another time interval. In some embodiments, the output of engine 300 (at step 414 of FIG. 4) can be a combination of item ranking 608 and 610.

The output (e.g., item ranking 608 and/or 610) of engine 300 (at step 414 of FIG. 4) can be transmitted, by engine 300, to a client device via an electronic communications network for presentation to a user of the client device. Some examples of users include without limitation, eCommerce users (e.g., online merchants), online advertisers, etc.

Other non-limiting examples of output generated by engine 300 (at step 414 of Figure) using one or more time-series model(s) include without limitation prediction of upcoming trends in the eCommerce industry, demand forecasting of popular products (say, in anticipation of seasonal increases in online shopping), detection decreases in product families (e.g., winter sports equipment), to name a few examples. Some further non-limiting examples include a bar graph showing the leading product categories bought online among internet users in a given geographic region (e.g., the United States) in a given time period (e.g., a given month and year) broken out by gender. An example of output can comprise a bar chart showing unit sales, revenue and average selling price of an item (e.g., Apple® iPhone®) by quarter (e.g., holiday quarter). As yet another example, item shipment information can be used to identify the top-ranked companies in the market.

In accordance with some embodiments, a history of item purchases by user can be used in determining the user's interests. A user's interests can be used to select online advertising for presentation to the user. The user's interests can be used to make recommendations (e.g., content recommendations in a content distribution system, friend recommendations in a social networking system, product recommendations on an eCommerce web site, etc.). The user's interests can be used in selecting and ranking of search results by a web search platform. The user's interest can be used to personalize a web page of the user using content identified in accordance with the user's interests. In some embodiments, users can be grouped based on common interests, by demographic segment(s), etc., and interests can be determined for a group of users and used alone or in combination with an individual user's interest.

Embodiments of the present disclosure provide a mechanism for aggregating information over a large number of merchants (e.g., using electronic message data generated by the merchants and sent to customers), and provides an ability to leverage user information across millions of electronic messaging users, as well as to analyze online (e.g., online shopping) user behavior. Online user behavior can be used to determine user interests. In addition, online user behavior can be used to infer other user properties, such as and without limitation income.

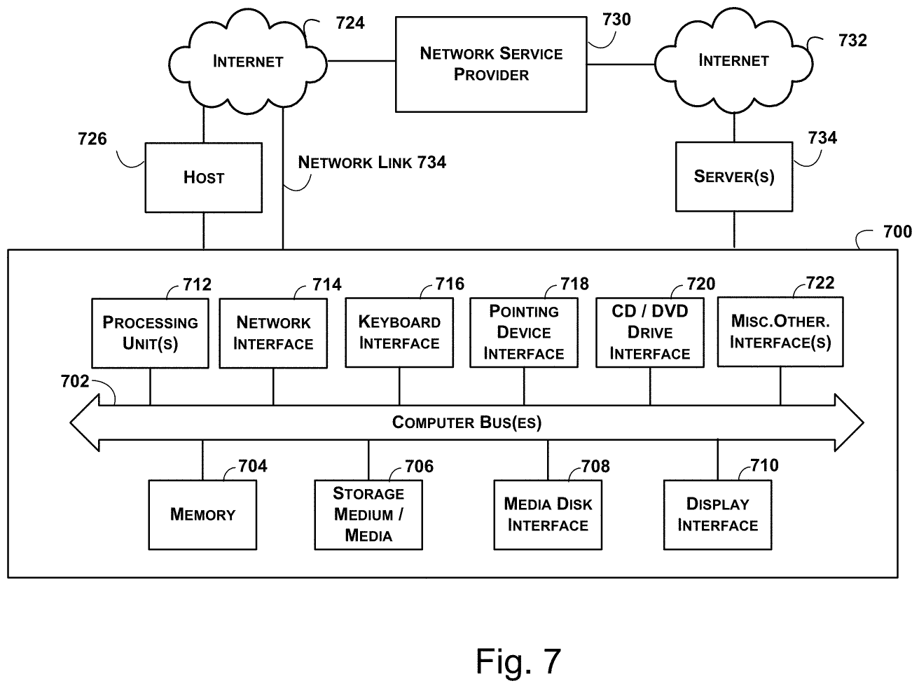

As shown in FIG. 7, internal architecture 700 of a computing device(s), computing system, computing platform, user devices, set-top box, smart TV and the like includes one or more processing units, processors, or processing cores, (also referred to herein as CPUs) 712, which interface with at least one computer bus 702. Also interfacing with computer bus 702 are computer-readable medium, or media, 706, network interface 714, memory 704, e.g., random access memory (RAM), run-time transient memory, read only memory (ROM), media disk drive interface 720 as an interface for a drive that can read and/or write to media including removable media such as floppy, CD-ROM, DVD, media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces and a universal serial bus (USB) interface.

Memory 704 interfaces with computer bus 702 so as to provide information stored in memory 704 to CPU 712 during execution of software programs such as an operating system, application programs, device drivers, and software modules that comprise program code, and/or computer executable process steps, incorporating functionality described herein, e.g., one or more of process flows described herein. CPU 712 first loads computer executable process steps from storage, e.g., memory 704, computer readable storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage, e.g., medium/media 706, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 728 typically provides information communication using transmission media through one or more networks to other devices that use or process the information. For example, network link 728 may provide a connection through local network 724 to a host computer 726 or to equipment operated by a Network or Internet Service Provider (ISP) 730. ISP equipment in turn provides data communication services through the public, worldwide packet-switching communication network of networks now commonly referred to as the Internet 732.

A computer called a server host 734 connected to the Internet 732 hosts a process that provides a service in response to information received over the Internet 732. For example, server host 734 hosts a process that provides information representing video data for presentation at display 710. It is contemplated that the components of system 700 can be deployed in various configurations within other computer systems, e.g., host and server.

At least some embodiments of the present disclosure are related to the use of computer system 700 for implementing some or all of the techniques described herein. According to one embodiment, those techniques are performed by computer system 700 in response to processing unit 712 executing one or more sequences of one or more processor instructions contained in memory 704. Such instructions, also called computer instructions, software and program code, may be read into memory 704 from another computer-readable medium 706 such as storage device or network link. Execution of the sequences of instructions contained in memory 704 causes processing unit 712 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 700. Computer system 700 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 702 as it is received, or may be stored in memory 704 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
obtaining, by a computing device and from a plurality of electronic messages of a plurality of electronic messaging system users, item purchase data indicative of past purchases of a number of items by the users during a time span, the item purchase data, for an item of the number, comprising temporal data indicative of a timing of each past purchase of the item;
determining, by the computing and for each item of the number, a set of popularity scores corresponding to a set of time periods of the time span, the determining comprising, for an item of the number and a time period of the set, determining a popularity score corresponding to a number of purchases of the item in the time period;
generating, by the computing device, training data using the set of popularity scores corresponding to the set of time periods associated with each item of the number of items;
training, by the computing device and using the training data and a machine learning process, a model for generating popularity score predictions;
generating, by the computing device and using the trained model, output comprising, for each item of the number of items, a set of predicted popularity scores corresponding to a set of future time periods; and
providing, by the computing device, output of the trained model.

2. The method of claim 1, the providing further comprising:
communicating, via the computing device, the output as a user interface display to a user computing device.

3. The method of claim 1, the output of the model comprising, for each future time period of the number of future time periods, a list comprising a set of items, of the number of items, the set of items in the list being ordered based on popularity score.

4. The method of claim 3, the set of items comprising a number of top-ranked items determined based on the popularity score of each item of the number.

5. The method of claim 1, for a future time period of the set of future time periods, an item's popularity score indicating a predicted number of purchases of the item in the future time period.

6. The method of claim 1, the model comprising a time-series analysis model.

7. The method of claim 1, further comprising:
updating, by the computing device, the model using updated training data, the updated training data being generated using item purchase data corresponding to another more recent time span, the other time span comprising at least one new time period from the set of future time periods;
training, by the computing device, the model using the updated training data;
generating, by the computing device, updated output comprising, for each item of the number of items, another set of predicted popularity scores corresponding to another set of future time periods corresponding to the other more recent time span; and
providing, by the computing device, the updated output.

8. The method of claim 1, each item of the number belonging to an item category.

9. The method of claim 8, further comprising:
training, by the computing device, an item categorization model using training data, the training data comprising a plurality of training examples, each training example comprising an item name and a category designation; and
determining, by the computing device and using the item categorization model, the item category of an item of the number, the determining comprising using an item name corresponding to the item as input to the item categorization model.

10. The method of claim 9, the item name corresponding to the item being a canonical name determined for the item using descriptive information included in the item purchase data.

11. The method of claim 8, further comprising:
identifying, by the computing device and using the item purchase data, an item of the number as a premium product in one item category, the premium product having a highest price in the category.

12. The method of claim 1, the item purchase data corresponding to a number of online merchants, and the set of popularity scores being determined across the number of online merchants.

13. The method of claim 1, the providing further comprising providing, for at least one item of the number, at least one popularity score determined using the item purchase data and providing at least one predicted popularity score.

14. The method of claim 1, further comprising:
determining, by the computing device and using the item purchase data, at least one seasonal trend for at least one item of the number of items.

15. A non-transitory computer-readable storage medium tangibly encoded with computer-executable instructions that when executed by a processor associated with a computing device perform a method comprising:
obtaining, from a plurality of electronic messages of a plurality of electronic messaging system users, item purchase data indicative of past purchases of a number of items by the users during a time span, the item purchase data, for an item of the number, comprising temporal data indicative of a timing of each past purchase of the item;
determining for each item of the number, a set of popularity scores corresponding to a set of time periods of the time span, the determining comprising, for an item of the number and a time period of the set, determining a popularity score corresponding to a number of purchases of the item in the time period;
generating training data using the set of popularity scores corresponding to the set of time periods associated with each item of the number of items;
training, using the training data and a machine learning process, a model for generating popularity score predictions;
generating, using the trained model, output comprising, for each item of the number of items, a set of predicted popularity scores corresponding to a set of future time periods; and
providing, by the computing device, output of the trained model.

16. The non-transitory computer-readable storage medium of claim 15, the output of the model comprising, for each future time period of the number of future time periods, a list comprising a set of items, of the number of items, the set of items in the list being ordered based on popularity score.

17. The non-transitory computer-readable storage medium of claim 16, the set of items comprising a number of top-ranked items determined based on the popularity score of each item of the number.

18. The non-transitory computer-readable storage medium of claim 15, further comprising:
updating the model using updated training data, the updated training data being generated using item purchase data corresponding to another more recent time span, the other time span comprising at least one new time period from the set of future time periods;
training the model using the updated training data;
generating updated output comprising, for each item of the number of items, another set of predicted popularity scores corresponding to another set of future time periods corresponding to the other more recent time span; and
providing the updated output.

19. The non-transitory computer-readable storage medium of claim 15, the item purchase data corresponding to a number of online merchants, and the set of popularity scores being determined across the number of online merchants.

20. A computing device comprising:
a processor;
a non-transitory storage medium for tangibly storing thereon program logic for execution by the processor, the program logic comprising:
obtaining logic executed by the processor for obtaining, from a plurality of electronic messages of a plurality of electronic messaging system users, item purchase data indicative of past purchases of a number of items by the users during a time span, the item purchase data, for an item of the number, comprising temporal data indicative of a timing of each past purchase of the item;
determining logic executed by the processor for determining, for each item of the number, a set of popularity scores corresponding to a set of time periods of the time span, the determining comprising, for an item of the number and a time period of the set, determining a popularity score corresponding to a number of purchases of the item in the time period;
generating logic executed by the processor for generating training data using the set of popularity scores corresponding to the set of time periods associated with each item of the number of items;
training logic executed by the processor for training, using the training data and a machine learning process, a model for generating popularity score predictions;
generating logic executed by the processor for generating, using the trained model, output comprising, for each item of the number of items, a set of predicted popularity scores corresponding to a set of future time periods; and
providing logic executed by the processor for providing output of the trained model.
